(19) United States
(12) Patent Application Publication
(10) Pub. No.: US 2023/0316170 A1
(43) Pub. Date: Oct. 5, 2023

(54) ENABLING DISTRIBUTING OF USER DATA AMONG PARTICIPANTS OF A MEETING

(71) Applicant: Telefonaktiebolaget LM Ericsson (publ), Stockholm (SE)

(72) Inventors: Tommy ARNGREN, Södra Sunderbyn (SE); Bernard SMEETS, Dalby (SE); Peter ÖKVIST, Luleå (SE)

(21) Appl. No.: 18/022,660

(22) PCT Filed: Aug. 26, 2020
(86) PCT No.: PCT/EP2020/073883

§ 371 Date: Feb. 22, 2023

(51) Int. Cl. G06Q 10/0631; G06Q 10/1093

(52) U.S. Cl. CPC G06Q 10/0631; G06Q 10/1095

(57) ABSTRACT

It is provided a method for enabling distributing of user data among users of respective user device, the users being participants of a meeting. The method is performed by an authenticator device and the method includes the steps of: receiving a signal based on a user action of a first user to enable data distribution; receiving a first set of attributes, including at least one attribute based on real-world data captured by a first user device of the first user; receiving a second set of attributes, including at least one attribute based on real-world data captured by a second user device of a second user, wherein the second set of attributes are of the same type as the first set of attributes; and enabling access to the user data for the user device of the second user when the first set of attributes match the second set of attributes.

### TECHNICAL FIELD

The present disclosure relates to the field of data distribution and in particular to a secure and convenient way to enable distributing of user data among users of respective user device, the users being participants of a meeting.

### BACKGROUND

While there is a trend towards more and more meetings happening digitally, physical meetings between people will always occur. Meetings can occur based on a booked appointment with known participants, time and location. However, meetings can also be ad-hoc, where participants, time and location may not be defined and associated with each other in advance.

When ad-hoc meetings occur, user data such as documents or other files might need to be shared between meeting participants. However, such sharing should be secure, and it should be ensured that only meeting participants get access to the user data. Since the identity of the participants may not be known, it is not trivial to authorise the participants. Lengthy and cumbersome identity exchange and authentication may need to be performed. It is to be noted that also for booked meetings, there can be ad-hoc participants.

It is evident that there is a clear need for a simple yet secure way for user data distribution among participants of a meeting when the association between participants is not predefined.

### SUMMARY

One object is to enable distributing of user data among users being participants of a meeting.

According to a first aspect, it is provided a method for enabling distributing of user data among users of respective user device, the users being participants of a meeting. The method is performed by an authenticator device and the method comprises the steps of: receiving a signal based on a user action of a first user to enable data distribution; receiving a first set of attributes, comprising at least one attribute based on real-world data captured by a first user device of the first user; receiving a second set of attributes, comprising at least one attribute based on real-world data captured by a second user device of a second user, wherein the second set of attributes are of the same type as the first set of attributes; and enabling access to the user data for the user device of the second user when the first set of attributes match the second set of attributes.

The step of enabling access to the user data may comprise encrypting the user data based on the first set of attributes.

The first set of attributes may comprise at least one attribute based on an image captured by a camera of the first user device.

The first set of attributes may comprise at least one attribute based on sounds captured by a microphone of the first user device.

The first set of attributes and the second set of attributes may have the same order of attribute types.

The steps of receiving a first set of attributes, receiving a second set of attributes and enabling access to data may be repeated regularly for revalidation.

The steps of receiving a second set of attributes and enabling access to data may be performed for a third user device of a third user.

The steps of receiving a first set of attributes, receiving a second set of attributes and enabling access to data may be repeated when at least one of the first user device, the second user device and the third user device are determined to have left a registered location of the meeting.

According to a second aspect, it is provided an authenticator device for enabling distributing of user data among users of respective user device, the users being participants of a meeting. The authenticator device comprises: a processor; and a memory storing instructions that, when executed by the processor, cause the authenticator device to: receive signal based on a user action of a first user to enable data distribution; receive a first set of attributes, comprising at least one attribute based on real-world data captured by a first user device of the first user; receive a second set of attributes, comprising at least one attribute based on real-world data captured by a second user device of a second user, wherein the second set of attributes are of the same type as the first set of attributes; and enable access to the user data for the user device of the second user when the first set of attributes match the second set of attributes.

The instructions to enable access to the user data may comprise instructions that, when executed by the processor, cause the authenticator device to encrypt the user data based on the first set of attributes.

The first set of attributes may comprise at least one attribute based on an image captured by a camera of the first user device.

The first set of attributes may comprise at least one attribute based on sounds captured by a microphone of the first user device.

The first set of attributes and the second set of attributes may have the same order of attribute types.

The authenticator device may further comprise instructions that, when executed by the processor, cause the authenticator device to repeat the instructions to receive a first set of attributes, receive a second set of attributes and enable access to data regularly for revalidation.

The authenticator device may further comprise instructions that, when executed by the processor, cause the authenticator device to perform the instructions to receive a second set of attributes and enable access to data for a third user device of a third user.

The authenticator device may further comprise instructions that, when executed by the processor, cause the authenticator device to repeat the instructions to receive a first set of attributes, receive a second set of attributes and enable access to data when at least one of the first user device, the second user device and the third user device are determined to have left a registered location of the meeting.

According to a third aspect, it is provided a computer program for enabling distributing of user data among users of respective user device, the users being participants of a meeting. The computer program comprises computer program code which, when executed on a authenticator device causes the authenticator device to: receive signal based on a user action of a first user to enable data distribution; receive a first set of attributes, comprising at least one attribute based on real-world data captured by a first user device of the first user; receive a second set of attributes, comprising at least one attribute based on real-world data captured by a second user device of a second user, wherein the second set of attributes are of the same type as the first set of attributes; and enable access to the user data for the user device of the second user when the first set of attributes match the second set of attributes.

According to a fourth aspect, it is provided a computer program product comprising a computer program according to the third aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIG. 2 is a schematic diagram illustrating the relationship between components to enable an embodiment applied in the environment of FIG. 1;

FIG. 3 is a schematic diagram illustrating potential components of the user devices of FIG. 1 and FIG. 2 according to one embodiment;

FIGS. 4A-B are flow charts illustrating embodiments of methods for enabling distributing user data among users;

FIG. 5 is a schematic diagram illustrating components of the authenticator device of FIG. 2 according to one embodiment;

FIG. 6 is a schematic diagram showing functional modules of the authenticator device of FIG. 2 according to one embodiment; and

FIG. 7 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

Embodiments presented herein provide an intuitive yet secure way to distribute user data among users being participants of a meeting. Access to the user data is based on attributes of real-world data captured by user device to evaluate whether the users are in proximity to each other, i.e. in the same place. This enables exchange of encrypted data between ad-hoc participants of a meeting using environmental characteristics. The attributes will be revoked as soon as the meeting is dissolved.

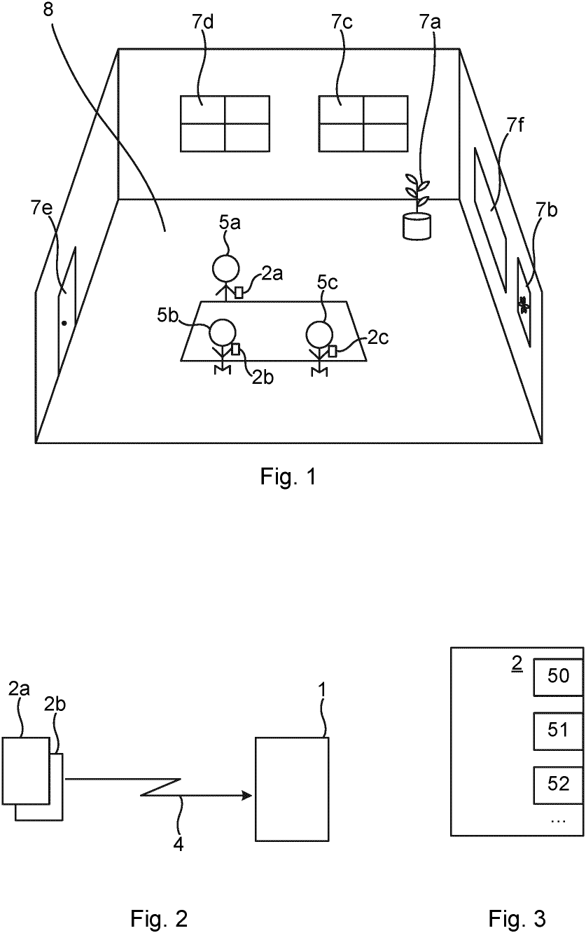

FIG. 1 is a schematic diagram illustrating an environment in which embodiments presented herein can be applied. This illustrates attribute-based proximity detection for user data distribution based on visual features.

A first user 5a has a first user device 2a. A second user 5b has a second user device 2b. A third user 5c has a third user device 2c. The users 5a-5c are participants of a meeting in a conference room 8. The meeting can have been arranged in advance or an ad-hoc meeting.

Each one of the user devices 2a-2c comprises one or more sensors for capturing real-world data as described in more detail below with reference to FIG. 3. Each user device 2a-2c can e.g. be a wearable device, a smartphone, a tablet computer, a laptop computer, etc.

In the conference room 8, there are a number of visual features 7a-e. Specifically, in this example, there is a first visual feature 7a in the form of a plant, a second visual feature 7b in the form of a painting, a third visual feature 7c in the form of a first window, a fourth visual feature 7d in the form of a second window and a fifth visual feature 7e in the form of a door. The mentioned visual features are only examples and other visual features can be used, including visual features of the room itself, e.g. corners, furniture, etc.

When cameras of the user devices 2a-c capture part or all of the visual features 7a-e in the conference room 8, these form attributes in the respective user devices 2a-c. An authenticator device 1 (see FIG. 2) compares the attributes from the user devices 2a-c. When the attributes match, the user devices are considered to be proximate, i.e. in the same location, and part of the same meeting. When this matching is affirmative, user data (e.g. documents or other files) can be shared between the user devices.

While the example of FIG. 1 performs proximity determination and authentication based on visual attributes, other attribute types can be used, as explained in more detail below.

FIG. 2 is a schematic diagram illustrating the relationship between components to enable an embodiment applied in the environment of FIG. 1.

A number of user devices 2a, 2b (two in this example) are in communication with an authenticator device 1 over a communication channel 4. The authenticator device 1 can be in the same location (e.g. same building) as the user devices 2a, 2b or in a remote location, e.g. in the cloud. The authenticator device 1 can be implemented as a single physical device or can be virtualised and spread over several physical devices.

The communication path 4 can be over an internet protocol (IP) based network. The network can e.g. comprise any one or more of a local wireless network, a cellular network, a wired local area network, a wide area network (such as the Internet), etc.

The authenticator device 1 can be a separate device as shown in FIG. 2. Alternatively, the authenticator device 1 can form part of one or more of the user devices 2a, 2b.

FIG. 3 is a schematic diagram illustrating potential components of the user devices 2A-B of FIG. 1 and FIG. 2 according to one embodiment, here represented by a single user device 2. Specifically, the sensor devices of the user device 2 are illustrated here. Other components, such as processor, user interface components and networking components are omitted for reasons of clarity.

The user device 2 can comprise a camera 50 capable of capturing visual data. The camera 50 can be capable of capturing any suitable frequency range, including any one or more of visible light, infrared light and ultraviolet light.

The user device 2 can comprise a microphone 51 capable of capturing audio data, optionally including sound above and/or under the audible frequency range, in addition to, or alternatively to, audible sound.

The user device 2 can comprise other sensor devices, e.g. a magnetometer 52, and/or any other sensor device capable of capturing real-world data.

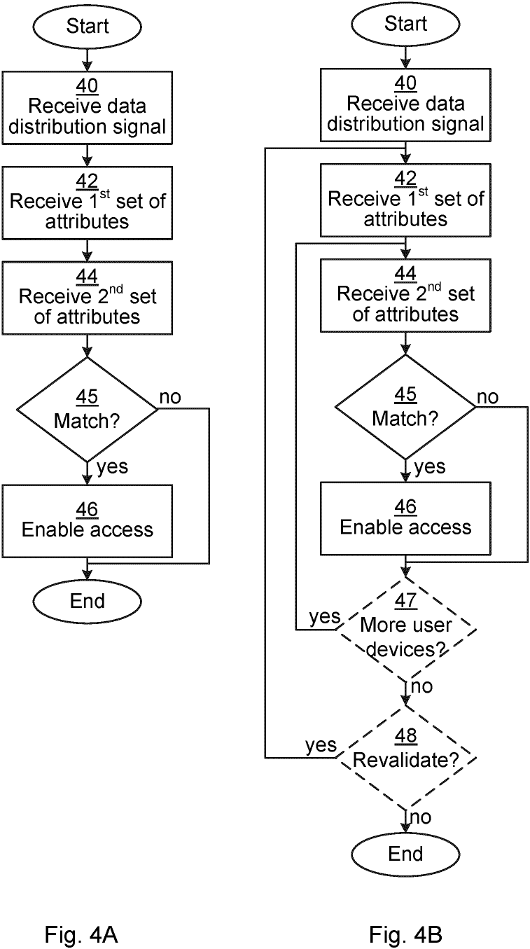

FIGS. 4A-B are flow charts illustrating embodiments of methods for enabling distributing user data among users, performed in an authenticator device 1.

In a receive data distribution signal step 40, the authenticator device 1 receives a signal based on a user action of a first user 5a to enable data distribution among the users of the meeting. In other words, a participant in the meeting triggers that the distribution of user data should be enabled.

In a receive 1^{st} set of attributes step 42, the authenticator device 1 receives a first set of attributes. The first set of attributes comprises at least one attribute based on real-world data captured by a first user device 2a of the first user 5a. In other words, the set of attributes relate to the real-world local environment of the first user device 2a, and thus also the first user 5a. For instance, the first set of attributes can comprise at least one attribute based on an image captured by a camera 50 of the first user device 2a. Alternatively or additionally, the first set of attributes comprises at least one attribute based on sounds captured by a microphone 51 of the first user device 2a. Alternative or additional attribute types are humidity, magnetic field, etc.

In a receive a 2^{nd} set of attributes step 44, the authenticator device 1 receives a second set of attributes. In analogy with the first set of attributes, the second set of attributes comprises at least one attribute based on real-world data captured by a second user device 2b of a second user 5b. The second set of attributes are of the same type as the first set of attributes. Furthermore, the first set of attributes and the second set of attributes can have the same order of attribute types, to make matching more efficient between the two sets of attributes, and/or to enable attribute-based encryption.

In a conditional match step 45, the authenticator device 1 determines if the first set of attributes matches the second set of attributes. The match can be determined by comparing the attribute values for each one of the (at least one) attribute types in the first set of attributes and the second set of attributes. This matching is performed as an indication that the first set of attributes and the second set of attributes are captured in proximity to each other. When there are multiple attribute types, the final matching can be based on a combination of the matchings of the individual attribute types. For instance, in one embodiment, the attributes of each one of the individual attribute types need to match. In one embodiment, the attributes of a sufficient proportion of the individual attribute types need to match. Other combinations of the individual attribute types can also be applied. Optionally, a level of matching for positive result for each attribute type is associated with the location of the user devices.

One matching of attributes can be based on comparing the attribute type of visual features in images captured by the two user devices. Optionally, the participants agree orally in the meeting on a specific order in which the visual features/attributes are captured. For instance, the order of visual features can be painting, plant, door (with reference to the example situation illustrated in FIG. 1). This gives even more certainty that the users are in the same location when their respective set of attributes contain the same visual features in the same order.

Optionally, a match is only positive when the attributes in the sets of attributes are captured at similar times, e.g. indicated that a difference between timestamps of the attributes and/or set of attributes is less than a threshold. This indicates also that the users are in the same location and agree to capture attributes offline, i.e. in an oral discussion with each other.

Alternatively or additionally, one type of matching of attributes can be based on comparing the attribute type of sound captured by microphones of the two devices, indicating proximity e.g. due to ambient fan noises, building or traffic noises or other sound similarities.

Alternatively or additionally, one type of matching of attributes can be based on comparing the attribute type of humidity captured by the two user devices.

Alternatively or additionally, one type of matching of attributes can be based on comparing the attribute type of colour temperature or UV components (which can vary e.g. due to artificial light or natural light sources), captured by the two devices.

Alternatively or additionally, one type of matching of attributes can be based on comparing the attribute types of light flickering, light pulse shapes, luminosity, duration of pulses, ripple of light variations.

Alternatively or additionally, one type of matching of attributes can be based on comparing the attribute types of strength, orientation or fluctuation of a magnetic field.

The matching between attributes of each attribute type from the two user devices can be based on the attributes being sufficiently similar based on a similarity threshold. Alternatively or additionally, the matching between attributes is based on a machine learning model.

When a match is determined based on one or more of the mentioned alternatives, the two user devices are considered to be proximate and the method proceeds to an enable access step 46. Otherwise, the method ends.

In the enable access step 46, the authenticator device 1 enables access to the user data for the user device 2b of the second user 5b. The enabling access to the user data can be based on an encryption of the user data based on the first set of attributes. The user data can e.g. comprise documents or other files that can be of use for the users of the meeting. The source of the user data can be one of the participants in the meeting or a file system accessible via the network.

The encryption can be based on attribute-based encryption (ABE) on the basis of the attributes captured by one or more or the user devices. For ABE to work, the order of the attribute types in the sets of attributes should be the same. ABE ensures that decryption can only be performed by devices which have access to the attributes used for the encryption. Since the attributes are based on environmental data capture, this ensures that only devices that are in the same environment, i.e. is proximate, can decrypt the user data.

Looking now to FIG. 4B, only new or modified steps compared to FIG. 4B will be described.

In an optional conditional more user devices step 47, the authenticator device 1 determines if there are more user devices for additional users to process, in which case the method returns to the receive 2^{nd} set of attributes step 44, but for the new device, e.g. third user device 2c of a third user 5c, etc. If there are no more user devices for additional users to process, the method proceeds to an optional conditional revalidate step 48, or, if step 48 is not performed, the method ends.

In an optional conditional revalidate step 48, the authenticator device 1 determines if revalidation should be performed, in which the method returns to the receive 1^{st} set of attributes step 42. Otherwise, the method ends.

Revalidation could e.g. be performed when at least one of the first user device 2a, the second user device 2b and the third user device 2c are determined to have left a registered location of the meeting. Optionally, revalidation could be performed when more than a predetermined proportion of participants have left the registered location of the meeting.

Alternatively or additionally, revalidation could be performed if a new user device enters and would like access to the user data.

Alternatively or additionally, revalidation could be performed when attributes change, i.e. due to changing lighting conditions. The attribute change can be monitored by polling one or more of the user devices from the authenticator device, or could be push based, by one of the user devices reporting when the attribute change is detected.

Alternatively or additionally, revalidation could be performed on a regular basis. The revalidation could be complete or different attributes can hold different time constants and may require different attribute monitoring frequencies. For example, meeting participants and associated user devices may change their positions during a meeting, one attendee may frequently lean back/forward on her chair with a e.g. 30s periodicity, whereas another person during an animated discussion frequently flaps her arm, which can trigger frequent attribute renewal/update. On the other hand light flickering and colour temperature are considered as environmental attributes, they are both plausible to be constant during the duration of the meeting, and may therefore require less or no attribute renewal during the ongoing meeting.

Additionally, access to the user data based on the first set of attributes can be deactivated if any of the user devices indicate that the meeting has ended.

Using the embodiments presented herein, data can be distributed among participants of a meeting without exchange of identities. It is sufficient that the user devices share the same attributes which are based on real-world data, i.e. that the user devices are in the same location. This provides a very user-friendly, yet secure, sharing of user data, e.g. among participants of a meeting. The solution is robust to tampering since first-person access to attributes in the form of real-world data is required.

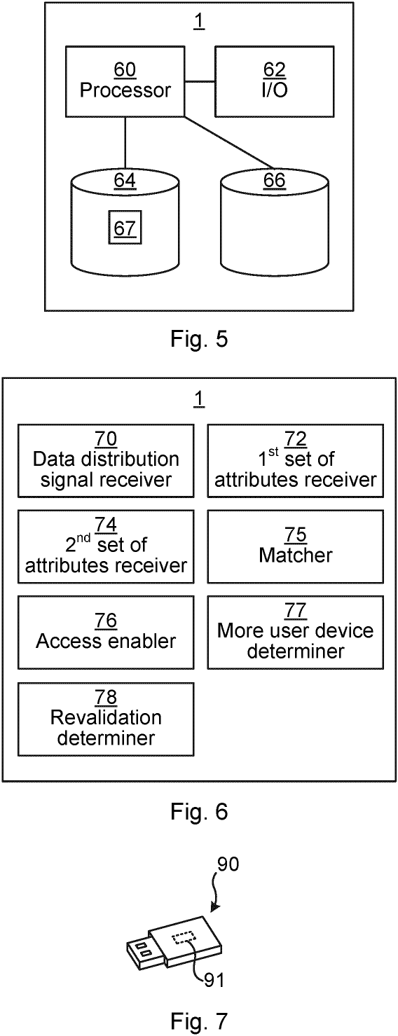

FIG. 5 is a schematic diagram illustrating components of the authenticator device 1 of FIG. 2. A processor 60 is provided using any combination of one or more of a suitable central processing unit (CPU), multiprocessor, microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIGS. 4A and 4B above.

The memory 64 can be any combination of random-access memory (RAM) and/or read-only memory (ROM). The memory 64 also comprises persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

The authenticator device 1 further comprises an I/O interface 62 for communicating with external and/or internal entities. Optionally, the I/O interface 62 also includes a user interface.

Other components of the authenticator device 1 are omitted in order not to obscure the concepts presented herein.

FIG. 6 is a schematic diagram showing functional modules of the authenticator device 1 of FIG. 2 according to one embodiment. The modules are implemented using software instructions such as a computer program executing in the authenticator device 1. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 4A and 4B.

A data distribution signal receiver 70 corresponds to step 40. A 1^{st} set of attributes receiver 72 corresponds to step 42. A 2^{nd} set of attributes receiver 74 corresponds to step 44. A matcher 75 corresponds to step 45. An access enabler 76 corresponds to step 46. A more user device determiner 77 corresponds to step 47. A revalidation determiner 78 corresponds to step 48.

FIG. 7 shows one example of a computer program product 90 comprising computer readable means. On this computer readable means, a computer program 91 can be stored, which computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 5. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for enabling distributing of user data among users of respective user device the users being participants of a meeting, the method being performed by an authenticator device and the method comprising the steps of:
receiving a signal based on a user action of a first user to enable data distribution;
receiving a first set of attributes, comprising at least one attribute based on real-world data captured by a first user device of the first user;
receiving a second set of attributes, comprising at least one attribute based on real-world data captured by a second user device of a second user wherein the second set of attributes are of the same type as the first set of attributes; and
enabling access to the user data for the user device of the second user when the first set of attributes match the second set of attributes.

2. The method according to claim 1, wherein the step of enabling access to the user data comprises encrypting the user data based on the first set of attributes.

3. The method according to claim 1, wherein the first set of attributes comprises at least one attribute based on an image captured by a camera of the first user device.

4. The method according to claim 1, wherein the first set of attributes comprises at least one attribute based on sounds captured by a microphone of the first user device.

5. The method according to claim 1, wherein the first set of attributes and the second set of attributes have the same order of attribute types.

6. The method according to claim 1, wherein the steps of receiving a first set of attributes, receiving a second set of attributes and enabling access to data are repeated regularly for revalidation.

7. The method according to claim 1, wherein the steps of receiving a second set of attributes and enabling access to data is performed for a third user device of a third user.

8. The method according to claim 7, wherein the steps of receiving a first set of attributes, receiving a second set of attributes and enabling access to data are repeated when at least one of the first user device, the second user device and the third user device are determined to have left a registered location of the meeting.

9. An authenticator device for enabling distributing of user data among users of respective user device the users being participants of a meeting, the authenticator device comprising:
a processor; and
a memory storing instructions that, when executed by the processor, cause the authenticator device to:
receive signal based on a user action of a first user to enable data distribution;
receive a first set of attributes, comprising at least one attribute based on real-world data captured by a first user device of the first user
receive a second set of attributes, comprising at least one attribute based on real-world data captured by a second user device of a second user wherein the second set of attributes are of the same type as the first set of attributes; and
enable access to the user data for the user device of the second user when the first set of attributes match the second set of attributes.

10. The authenticator device according to claim 9, wherein the instructions to enable access to the user data comprise instructions that, when executed by the processor, cause the authenticator device to encrypt the user data based on the first set of attributes.

11. The authenticator device according to claim 9, wherein the first set of attributes comprises at least one attribute based on an image captured by a camera of the first user device.

12. The authenticator device according to claim 9, wherein the first set of attributes comprises at least one attribute based on sounds captured by a microphone of the first user device.

13. The authenticator device according to claim 9, wherein the first set of attributes and the second set of attributes have the same order of attribute types.

14. The authenticator device according to claim 9, further comprising instructions that, when executed by the processor, cause the authenticator device to repeat the instructions to receive a first set of attributes, receive a second set of attributes and enable access to data regularly for revalidation.

15. The authenticator device according to claim 9, further comprising instructions that, when executed by the processor, cause the authenticator device to perform the instructions to receive a second set of attributes and enable access to data for a third user device of a third user.

16. The authenticator device according to claim 15, further comprising instructions that, when executed by the processor, cause the authenticator device to repeat the instructions to receive a first set of attributes, receive a second set of attributes and enable access to data when at least one of the first user device, the second user device and the third user device are determined to have left a registered location of the meeting.

17. A computer program product for enabling distributing of user data among users of respective user device the users being participants of a meeting, the computer program product comprising a non-transitory computer readable medium storing computer program code which, when executed on a authenticator device causes the authenticator device to:
receive signal based on a user action of a first user to enable data distribution;
receive a first set of attributes, comprising at least one attribute based on real-world data captured by a first user device of the first user;
receive a second set of attributes, comprising at least one attribute based on real-world data captured by a second user device of a second user, wherein the second set of attributes are of the same type as the first set of attributes; and
enable access to the user data for the user device of the second user when the first set of attributes match the second set of attributes.

18. (canceled)
